(19) United States
(12) Patent Application Publication
(10) Pub. No.: US 2016/0328996 A1
(43) Pub. Date: Nov. 10, 2016

(54) Board Game Assembly

(71) Applicant: Kelly Hamner, Santa Clara, CA (US)

(72) Inventor: Kelly Hamner, Santa Clara, CA (US)

(21) Appl. No.: 14/707,052

(22) Filed: May 8, 2015

(51) Int. Cl. G09B 19/22; G09B 19/00

(52) U.S. Cl. CPC G09B 19/22; G09B 19/00

(57) ABSTRACT

A board game assembly includes a box that has a top surface, a bottom surface and a peripheral edge extending between the top surface and the bottom surface. The bottom surface may be positioned on a support surface and the top surface has indicia printed thereon. A plurality of panels is provided and each of the panels has an upper surface, a lower surface and an extraneous edge extending between the upper surface and the lower surface. The upper surface of each of the panels has indicia printed thereon. A selected one of the panels is positionable on the box having the lower surface of the selected panel abutting the top surface of the box. A plurality of tokens is provided and each of the tokens is placed on the box.

### BACKGROUND OF THE DISCLOSURE

### Field of the Disclosure

The disclosure relates to game devices and more particularly pertains to a new game device for teaching basic life skills and problems solving skills to developmentally disabled players.

### SUMMARY OF THE DISCLOSURE

An embodiment of the disclosure meets the needs presented above by generally comprising a box that has a top surface, a bottom surface and a peripheral edge extending between the top surface and the bottom surface. The peripheral edge has a front side, a back side, a first lateral side and a second lateral side. The bottom surface may be positioned on a support surface and the top surface has indicia is printed thereon. A plurality of panels is provided and each of the panels has an upper surface, a lower surface and an extraneous edge extending between the upper surface and the lower surface. The upper surface of each of the panels has indicia printed thereon. A selected one of the panels is positionable on the box having the lower surface of the selected panel abutting the top surface of the box. Thus, the indicia on the selected panel are aligned with the first lateral side, the front side and the second lateral side of the box. A plurality of tokens is provided and each of the tokens is placed on the box.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a kit view of a board game assembly according to an embodiment of the disclosure.

FIG. 2 is a perspective view of an embodiment of the disclosure.

FIG. 3 is a top view of an embodiment of the disclosure.

FIG. 4 is a schematic view of an embodiment of the disclosure.

FIG. 5 is a top perspective in-use view of an embodiment of the disclosure.

FIG. 6 is a right side in-use view of an embodiment of the disclosure.

### DESCRIPTION OF THE PREFERRED EMBODIMENT

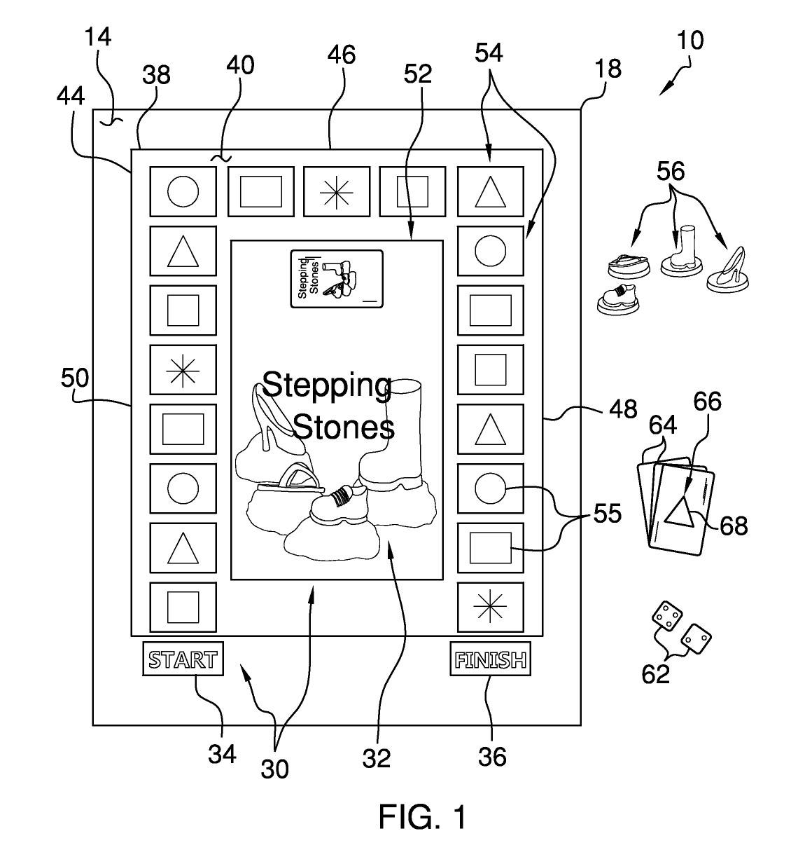

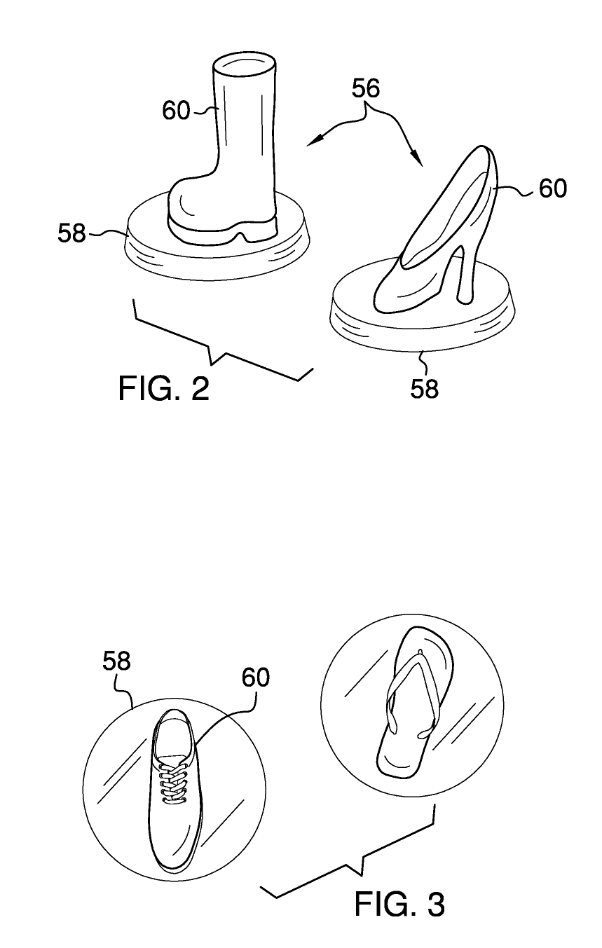

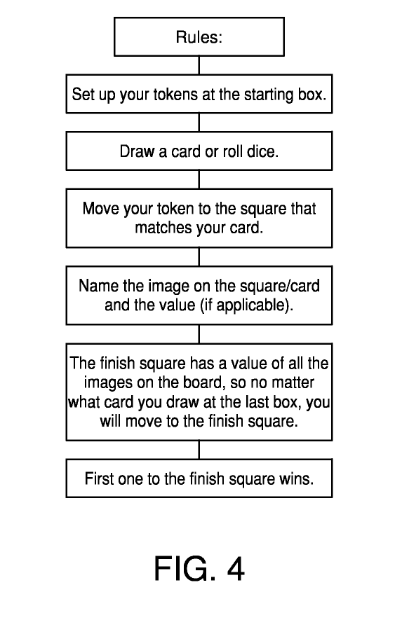

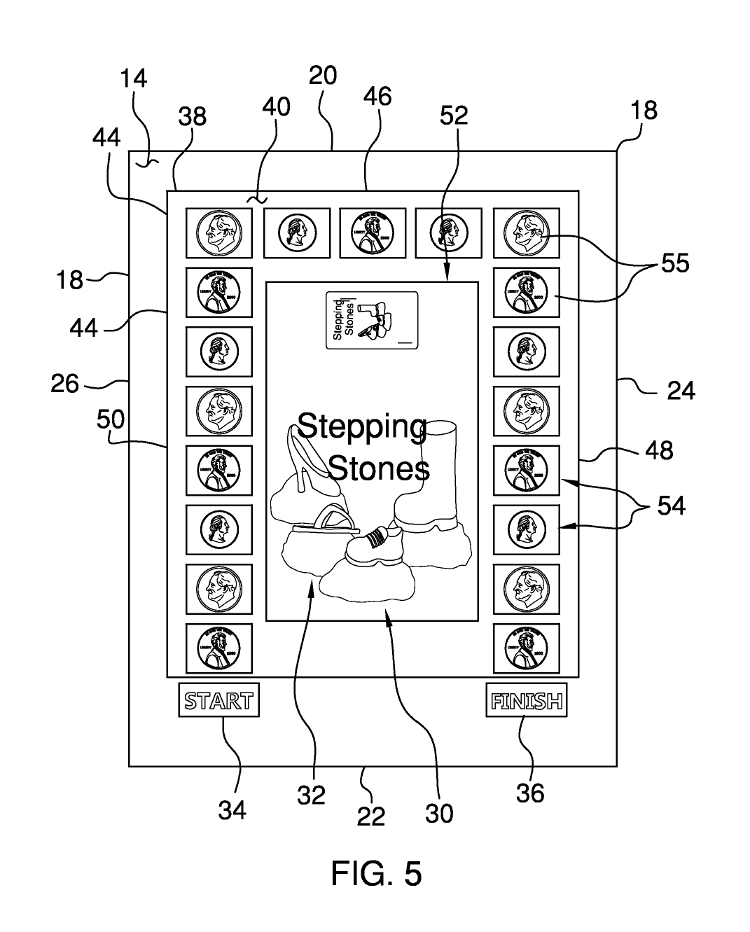

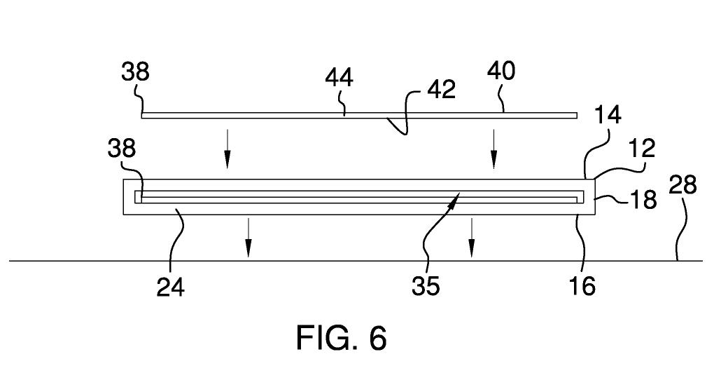

With reference now to the drawings, and in particular to FIGS. 1 through 6 thereof, a new game device embodying the principles and concepts of an embodiment of the disclosure and generally designated by the reference numeral 10 will be described.

As best illustrated in FIGS. 1 through 6, the board game assembly 10 generally comprises a box 12 has a top surface 14, a bottom surface 16 and a peripheral edge 18 extending between the top surface 14 and the bottom surface 16. The peripheral edge 18 has a front side 20, a back side 22, a first lateral side 24 and a second lateral side 26. The bottom surface 16 may be positioned on a support surface 28.

The top surface 14 has indicia 30 printed thereon and the indicia 30 include a logo 32 that is centrally positioned on the top surface 14. The logo 32 may include the words “Stepping Stones”. The indicia 30 additionally include a start square 34 that is positioned adjacent to an intersection of the front side 20 and the second lateral side 26. The indicia 30 include a finish square 36 that is positioned adjacent to an intersection of the front side 20 and the second lateral side 26. The first lateral side 24 has a slot 35 extending therethrough to access an interior of the box 12 and the slot 35 is substantially coextensive with the first lateral side 24.

A plurality of panels 38 is provided and each of the panels 38 has an upper surface 40, a lower surface 42 and an extraneous edge 44 extending between the upper surface 40 and the lower surface 42. The extraneous edge 44 of each of the panels 38 has a forward side 46, a first side 48 and a second side 50. Each of the panels 38 has an opening 52 extending through the upper surface 40 and the lower surface 42 and the opening 52 is centrally positioned on each of the panels 38.

The upper surface 40 of each of the panels 38 has indicia 54 printed on the upper surface 40. The indicia 54 on each of the panels are distributed along the first side 48, the forward side 46 and the second side 50. The indicia 54 on each of the panels 38 comprise images 55 and each of the panels 38 has unique images 55 with respect to each other. The images 55 on each of the respective panels may comprise images relating to mathematics, science, history and music. Each of the panels 38 is selectively insertable through the slot 35 in the box 12 such that each of the panels 38 is stored within the box 12.

A selected one of the panels 38 is positionable on the box 12 having the lower surface 42 of the selected panel 38 abutting the top surface 14 of the box 12. The indicia 54 on the selected panel 38 are aligned with the first lateral side 24, the front side 20 and the second lateral side 26 of the box 12. The logo 32 on the top surface 14 of the box 12 is uncovered when the selected panel 38 is positioned on the box 12.

A plurality of tokens 56 is provided and each of the tokens 56 comprises a base 58 and a monument 60. The monument 60 of each of the tokens 56 has a unique shape with respect to each other. The monuments 60 of each of the tokens 56 may comprise different types of footwear such as shoes, boots, sandals and other footwear. The base 58 of selected ones of the tokens 56 is placed on the start square 36 on the box 12 to begin game play.

A pair of dice 62 is provided to be used in the convention of game play. A plurality of cards 64 is provided and each of the cards 64 has indicia 66 printed thereon. The indicia 66 on each of the cards 64 are unique with respect to each other and the indicia 66 on each of the cards comprise an image 68. The image 68 on each of the cards 64 matches a corresponding one of the images 55 on the panels 38. Each of the tokens 56 is selected by corresponding players and each of the players may be developmentally disabled. The image 68 on each of the cards 64 and the images 55 on the panels 38 are images intended to assist each of the players to learn basic life skills and basic problem solving skills

In use, the selected panel 38 is chosen based upon the subject matter displayed on the images 55 on the selected panel 38. The selected panel 38 is placed on the box 12 and each player of the game selects one of the tokens 56. A card 64 is drawn by each player and the token 56 corresponding to each player is placed onto one of the images 55 on the panel 38 that matches the image 68 on the card 64 that was drawn. Each player attempts to verbally state the proper name of the image 55 on the panel 38 or to solve a mathematical problem posed by the image 55 on the panel 38. Each player draws an additional card 64 if the player correctly names the image 55 on the panel 38 or correctly solves the mathematical problem posed by the image 55 on the panel 38. Each player's turn is over when the player fails to correctly name the image 55 on the panel 38 or if the player fails to correctly solve the mathematical problem posed by the image 55 on the panel 38. Each player's token 56 is moved between the start square 34 and the finish square 36 when each player correctly names the images 55 or correctly solves the mathematical problems. The first player to successfully move the respective token 56 to the finish square 36 wins the game.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A board game assembly configured to teach a plurality of life skills to a mentally disabled user, said assembly comprising:
a box having a top surface, a bottom surface and a peripheral edge extending between said top surface and said bottom surface, said peripheral edge having a front side, a back side, a first lateral side and a second lateral side, said bottom surface being configured to be positioned on a support surface, said top surface having indicia being printed thereon;
a plurality of panels, each of said panels having an upper surface, a lower surface and an extraneous edge extending between said upper surface and said lower surface, said upper surface of each of said panels having indicia being printed thereon, a selected one of said panels being positionable on said box having said lower surface of said selected panel abutting said top surface of said box such that said indicia on said selected panel is aligned with said first lateral side, said front side and said second lateral side of said box; and
a plurality of tokens, each of said tokens being placed on said box.

2. The assembly according to claim 1, wherein said indicia on said box including a logo being centrally positioned on said top surface, said indicia including a start square being positioned adjacent to an intersection of said front side and said second lateral side, said indicia including a finish square being positioned adjacent to an intersection of said front side and said second lateral side.

3. The assembly according to claim 2, wherein said first lateral side having a slot extending therethrough to access an interior of said box, said slot being substantially coextensive with said first lateral side.

4. The assembly according to claim 1, wherein said extraneous edge of each of said panels having a forward side, a first side and a second side, each of said panels having an opening extending through said upper surface and said lower surface, said opening being centrally positioned on each of said panels.

5. The assembly according to claim 4, wherein said indicia on each of said panels being distributed along said first side, said forward side and said second side, said indicia on each of said panels comprising images, each of said panels having unique images with respect to each other.

6. The assembly according to claim 1, wherein:
said box has a slot; and
each of said panels being selectively insertable through said slot in said box such that each of said panels is stored within said box.

7. The assembly according to claim 1, wherein each of said tokens comprises a base and a monument, said monument of each of said tokens having a unique shape with respect to each other, each of said tokens being selected by one of a plurality of players, said base of selected ones of said tokens being placed on said start square on said box.

8. The assembly according to claim 1, wherein:
said indicia on each of said panels comprising an image; and
a plurality of cards, each of said cards having indicia printed thereon, said indicia on each of said cards being unique with respect to each other, said indicia on each of said cards comprising an image, said image on each of said cards matching a corresponding one of said images on said panel.

9. A board game assembly configured to teach a plurality of life skills to a mentally disabled user, said assembly comprising:
a box having a top surface, a bottom surface and a peripheral edge extending between said top surface and said bottom surface, said peripheral edge having a front side, a back side, a first lateral side and a second lateral side, said bottom surface being configured to be positioned on a support surface, said top surface having indicia being printed thereon, said indicia including a logo being centrally positioned on said top surface, said indicia including a start square being positioned adjacent to an intersection of said front side and said second lateral side, said indicia including a finish square being positioned adjacent to an intersection of said front side and said second lateral side, said first lateral side having a slot extending therethrough to access an interior of said box, said slot being substantially coextensive with said first lateral side;
a plurality of panels, each of said panels having an upper surface, a lower surface and an extraneous edge extending between said upper surface and said lower surface, said extraneous edge of each of said panels having a forward side, a first side and a second side, each of said panels having an opening extending through said upper surface and said lower surface, said opening being centrally positioned on each of said panels, said upper surface of each of said panels having indicia being printed thereon, said indicia on each of said panels being distributed along said first side, said forward side and said second side, said indicia on each of said panels comprising images, each of said panels having unique images with respect to each other, each of said panels being selectively insertable through said slot in said box such that each of said panels is stored within said box, a selected one of said panels being positionable on said box having said lower surface of said selected panel abutting said top surface of said box such that said indicia on said selected panel is aligned with said first lateral side, said front side and said second lateral side of said box, said logo on said top surface of said box being uncovered when said selected panel is positioned on said box;
a plurality of tokens, each of said tokens comprising a base and a monument, said monument of each of said tokens having a unique shape with respect to each other, said base of selected ones of said tokens being placed on said start square on said box; and
a plurality of cards, each of said cards having indicia printed thereon, said indicia on each of said cards being unique with respect to each other, said indicia on each of said cards comprising an image, said image on each of said cards matching a corresponding one of said images on said panel.
